(19) United States
(12) Patent Application Publication
(10) Pub. No.: US 2025/0054452 A1
(43) Pub. Date: Feb. 13, 2025

(54) DISPLAY DEVICE AND OPERATION METHOD THEREOF

(71) Applicant: Qisda Corporation, Taoyuan City (TW)

(72) Inventors: Chao-Shun Yu, Taoyuan City (TW); Wen-Chang Chen, Taoyuan City (TW); Chun-Sheng Hu, Taoyuan City (TW)

(73) Assignee: Qisda Corporation, Taoyuan City (TW)

(21) Appl. No.: 18/769,362

(22) Filed: Jul. 10, 2024

(30) Foreign Application Priority Data
Aug. 10, 2023 (TW) 112130084

(51) Int. Cl. G09G 3/34; G09G 3/20

(52) U.S. Cl. CPC G09G 3/3406; G09G 3/2096; G09G 2300/026; G09G 2320/0686; G09G 2354/00

(57) ABSTRACT

The invention provides a display device and an operation method thereof. The display device includes a calculation unit and a local dimming driving unit. The calculation unit generates image data for displaying on a display panel. The calculation unit determines a location of a mouse pointer (cursor) in the image data based on an operation of a user interface device. The calculation unit defines an attention area corresponding to the mouse pointer based on the location of the mouse pointer. Based on information of the calculation unit, the local dimming driving unit enables a local dimming function for the attention area corresponding to the location of the mouse pointer, or disables the local dimming function for a non-attention area outside the attention area.

### CROSS-REFERENCE TO RELATED APPLICATION

This application claims the priority benefit of Taiwan application serial no. 112130084, filed on Aug. 10, 2023. The entirety of the above-mentioned patent application is hereby incorporated by reference herein and made a part of specification.

### BACKGROUND OF THE INVENTION

### Field of the Invention

The invention relates to an electronic device, and particularly relates to a display device and an operation method thereof.

### Description of Related Art

Known displays enable local dimming function for all images on the display panel. Local dimming refers to local backlight adjustment. The backlight light-emitting element may be adjusted differently in different areas according to the image brightness of the display panel. Therefore, the brightness of the highlighted portions in the displayed image may be maximized, and at the same time the brightness of the dark portions may be reduced (or even the backlight of this area is disabled) to increase the contrast. In addition, reducing the brightness of dark portions may reduce the power consumption of the backlight.

However, local dimming requires graphics processing unit (GPU) computing resources. For large display screens (a single display panel or a display wall composed of a plurality of display panels), the user usually only focuses on a specific area (attention area) of the large display screen. For other areas perceived by the peripheral vision of the user (even areas not seen by the eyes, collectively referred to as non-attention areas), it is usually difficult for the user to feel the enhanced display effect of local dimming on the non-attention areas. In other words, enabling the local dimming function for non-attention areas is a waste of computing resources.

### SUMMARY OF THE INVENTION

The invention provides a display device and an operation method thereof to independently enable or disable local dimming function for different locations in image data.

In an embodiment of the invention, a display device includes a calculation unit and a local dimming driving unit. The calculation unit generates at least one image data for displaying on at least one display panel. In particular, the calculation unit determines a location of a mouse pointer in the at least one image data based on an operation of a user interface device, and the calculation unit defines an attention area corresponding to the mouse pointer based on the location of the mouse pointer. The local dimming driving unit is coupled to the calculation unit. Based on information of the calculation unit, the local dimming driving unit enables a local dimming function for the attention area corresponding to the location of the mouse pointer, or disables the local dimming function for a non-attention area outside the attention area.

In an embodiment of the invention, an operation method includes: generating at least one image data via a calculation unit of a display device for displaying on at least one display panel; determining a location of a mouse pointer in the at least one image data based on an operation of a user interface device via the calculation unit; defining an attention area corresponding to the mouse pointer based on the location of the mouse pointer via the calculation unit; and enabling a local dimming function for the attention area corresponding to the location of the mouse pointer or disabling the local dimming function for a non-attention area outside the attention area based on information of the calculation unit via a local dimming driving unit of the display device.

Based on the above, the calculation unit of the embodiments of the invention may determine the location of the mouse pointer in the image data based on the operation of the user interface device. In a general operating situation, the location of the mouse pointer is the specific area that the user is looking at (the attention area). The calculation unit may define the attention area in the image data based on the location of the mouse pointer in the image data. Using the mouse pointer as a guide, the local dimming driving unit may enable the local dimming function for a specific area, and disable the local dimming function in other areas (non-attention areas) outside the specific area. Therefore, the display device may independently enable or disable the local dimming function for different locations in the image data to reduce hardware computing resources.

In order to make the aforementioned features and advantages of the disclosure more comprehensible, embodiments accompanied with figures are described in detail below.

### BRIEF DESCRIPTION OF THE DRAWINGS

FIG. 1 is a schematic circuit block diagram of a display device according to an embodiment of the invention.

FIG. 2 is a schematic flowchart of an operation method of a display device according to an embodiment of the invention.

FIG. 3 is a schematic diagram of an “attention area” shown according to an embodiment of the invention.

FIG. 4 is a schematic diagram of an “attention area” shown according to another embodiment of the invention.

FIG. 5 is a schematic diagram of an “attention area” shown according to another embodiment of the invention.

FIG. 6 is a schematic diagram of an “attention area” shown according to another embodiment of the invention.

FIG. 7 is a schematic circuit block diagram of a calculation unit and a local dimming driving unit shown according to an embodiment of the invention.

### DESCRIPTION OF THE EMBODIMENTS

The term “coupled to (or connected to)” used in the entire text of the specification of the present application (including claims) may refer to any direct or indirect connecting means. For example, if it is herein described that a first device is coupled (or connected) to a second device, it should be interpreted that the first device may be directly connected to the second device, or the first device may be indirectly connected to the second device via other devices or some connection means. Terms such as “first” and “second” mentioned throughout the specification (including the claims) of the present application are used to name elements or to distinguish between different embodiments or scopes, and are not used to limit the upper bound or the lower bound of the number of elements, nor used to limit the sequence of elements. In addition, wherever possible, elements/members/steps using the same reference numerals in the drawings and embodiments denote the same or similar portions. Cross-reference may be made to relevant descriptions of elements/members/steps using the same reference numerals or using the same terms in different embodiments.

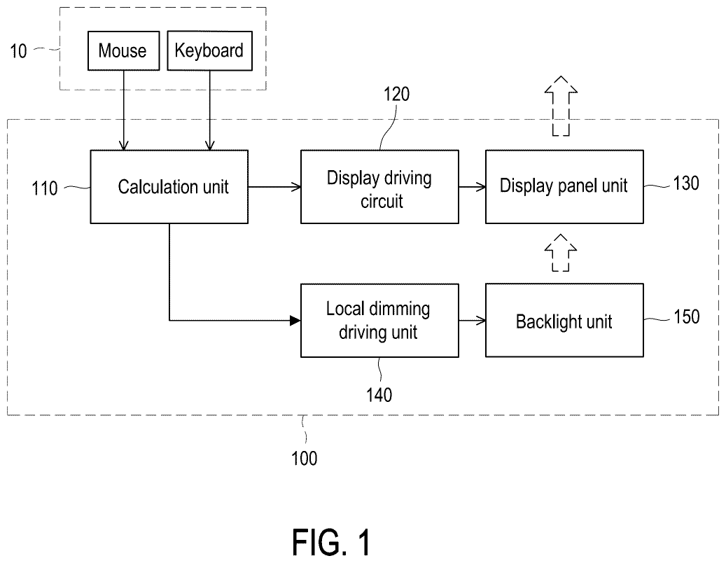

FIG. 1 is a schematic circuit block diagram of a display device 100 according to an embodiment of the invention. The user may operate the display device 100 via a user interface device 10. Based on actual design, the user interface device 10 may include a mouse, a keyboard, a touch panel, and/or other user interface devices. The display device 100 shown in FIG. 1 includes a calculation unit 110, a display driving circuit 120, a display panel unit 130, a local dimming driving unit 140, and a backlight unit 150. According to different designs, in some embodiments, the calculation unit 110 may be implemented as a hardware circuit. In some other embodiments, the calculation unit 110 may be implemented in firmware, software (program), or a combination of the two. In some other embodiments, the calculation unit 110 may be implemented in a combination of hardware, firmware, and software.

In terms of hardware, the calculation unit 110 may be implemented as a logic circuit on an integrated circuit. For example, the related functions of the calculation unit 110 may be implemented in one or a plurality of controllers, microcontrollers, microprocessing units, application-specific integrated circuits (ASICs), digital signal processing units (DSPs), field-programmable gate arrays (FPGAs), central processing units (CPUs), and/or various logic blocks, modules, and circuits in other processing units. The relevant functions of the calculation unit 110 may be implemented as a hardware circuit by using a hardware description language (such as Verilog HDL or VHDL) or other suitable programming languages, such as various logic blocks, modules, and circuits in an integrated circuit.

In software form and/or firmware form, the related functions of the calculation unit 110 may be implemented as programming codes. For example, the calculation unit 110 is implemented by using a common programming language (e.g., C, C++, or assembly language) or other suitable programming languages. The programming code may be recorded/stored in a “non-transitory machine-readable storage medium”. In some embodiments, the non-transitory machine-readable storage medium includes, for example, a semiconductor memory and/or a storage device. An electronic equipment (such as a computer, CPU, controller, microcontroller, or microprocessing unit) may read and execute the programming code from the non-transitory machine-readable storage medium, so as to implement the related functions of the calculation unit 110.

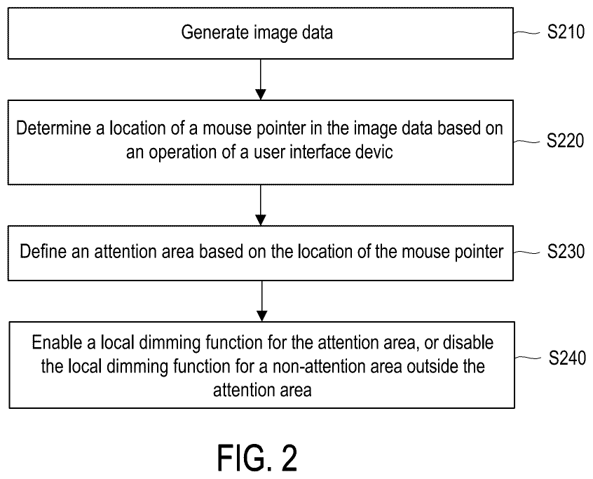

FIG. 2 is a schematic flowchart of an operation method of a display device according to an embodiment of the invention. Please refer to FIG. 1 and FIG. 2. The display driving circuit 120 is coupled to the calculation unit 110 and the display panel unit 130. In step S210, the calculation unit 110 may generate at least one image data for displaying on the display panel unit 130 to the display driving circuit 120. Based on the control of the calculation unit 110, the display driving circuit 120 may drive the display panel unit 130 to display an image corresponding to the image data. Based on actual design, the display panel unit 130 may include a liquid-crystal display (LCD) panel or other display panels. Based on actual design, the display panel unit 130 may be a single display panel, or the display panel unit 130 may include a plurality of display panels. For example, in some embodiments, two or more display panels (the display panel unit 130) may jointly present a game image. In other embodiments, a plurality of display panels (the display panel units 130) may form a display wall.

The calculation unit 110 is also coupled to the user interface device 10. In step S220, based on the operation of the user on the user interface device 10, the calculation unit 110 may determine the location of the mouse pointer in the image data (i.e., the location of the mouse pointer in the image displayed by the display panel unit 130). In a general operating situation, the location of the mouse pointer is the specific area that the user is looking at (the attention area). In step S230, based on the location of the mouse pointer, the calculation unit 110 may define an attention area corresponding to the mouse pointer. In different actual design examples and/or in different application situations, the attention area may have different forms.

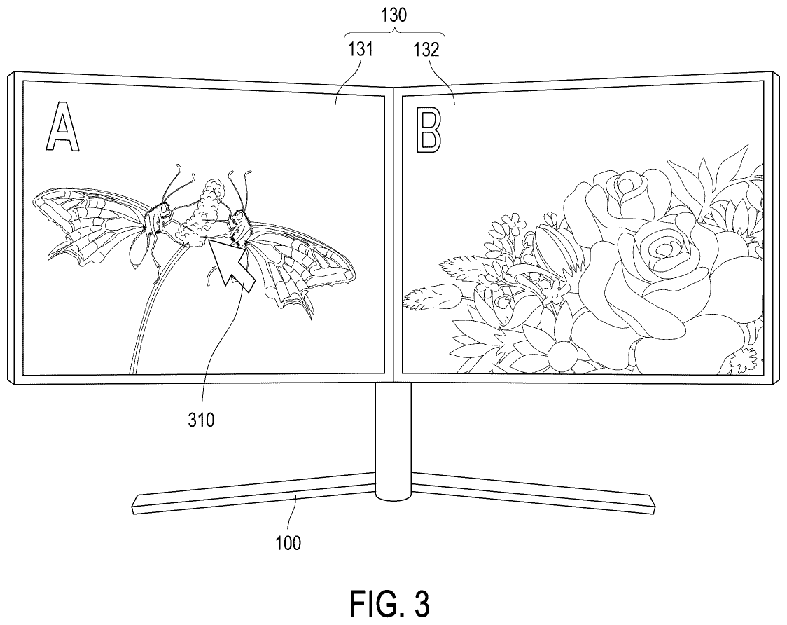

FIG. 3 is a schematic diagram of an “attention area” shown according to an embodiment of the invention. In the embodiment shown in FIG. 3, the display panel unit 130 may include a plurality of display panels, such as the display panel 131 and the display panel 132 shown in FIG. 3. The calculation unit 110 may generate different image data so that the display panel 131 and the display panel 132 display different images. For example, the display panel 131 displays “A” and the display panel 132 displays “B”. Based on the operation of the user on the user interface device 10, a mouse pointer 310 may move to any location of the display panel 131 and the display panel 132. The “attention area” may be the entire display area of the display panel in the display panels 131 and 132 where the mouse pointer 310 is located. As an example of an operating situation, it is assumed that the user moves the mouse pointer 310 to the image displayed on the display panel 131. Based on the location of the mouse pointer 310, the calculation unit 110 may define the entire display area of the display panel 131 as the attention area corresponding to the mouse pointer 310, and the entire display area of the display panel 132 serves as a non-attention area. By analogy, when the mouse pointer 310 moves to the image displayed on the display panel 132, the calculation unit 110 may define the entire display area of the display panel 132 as the attention area corresponding to the mouse pointer 310, and the entire display area of the display panel 131 serves as a non-attention area.

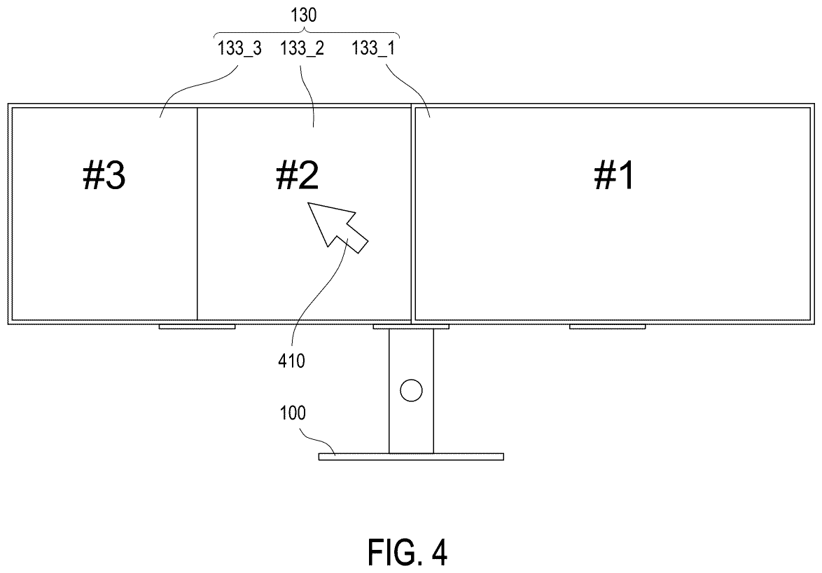

FIG. 4 is a schematic diagram of an “attention area” shown according to another embodiment of the invention. In the embodiment shown in FIG. 4, the display panel unit 130 may include a single display panel, but the entire display area of the display panel is divided into a plurality of sub-areas to display a plurality of screens. The calculation unit 110 may generate different image data so that the sub-display areas 133_1, 133_2, and 133_3 shown in FIG. 4 display different screens. For example, the sub-display area 133_1 displays “#1”, the sub-display area 133_2 displays “#2”, and the sub-display area 133_3 displays “#3”. According to actual design, the division of the sub-display areas 133_1, 133_2, and 133_3 may be static sub-areas or dynamic sub-areas determined based on actual operating situations. For example, in some actual operation situations, each of the screens displayed in the sub-display areas 133_1, 133_2, and 133_3 may be an application window.

Based on the operation of the user on the user interface device 10, a mouse pointer 410 may move at any location in the sub-display areas 133_1, 133_2, and 133_3. The “attention area” may be the entirety of a screen where the mouse pointer 410 is located in the different screens displayed in the sub-display areas 133_1, 133_2, and 133_3. As an example of an operating situation, it is assumed that the user moves the mouse pointer 410 to the sub-display area 133_2. Based on the location of the mouse pointer 410, the calculation unit 110 may define the entire screen of the sub-display area 133_2 as the attention area corresponding to the mouse pointer 410, and the other sub-display areas 133_1 and 133_3 as non-attention areas. By analogy, when the mouse pointer 410 moves to the sub-display area 133_1, the calculation unit 110 may define the entire screen of the sub-display area 133_1 as the attention area corresponding to the mouse pointer 410, and the other sub-display areas 133_2 and 133_3 as non-attention areas.

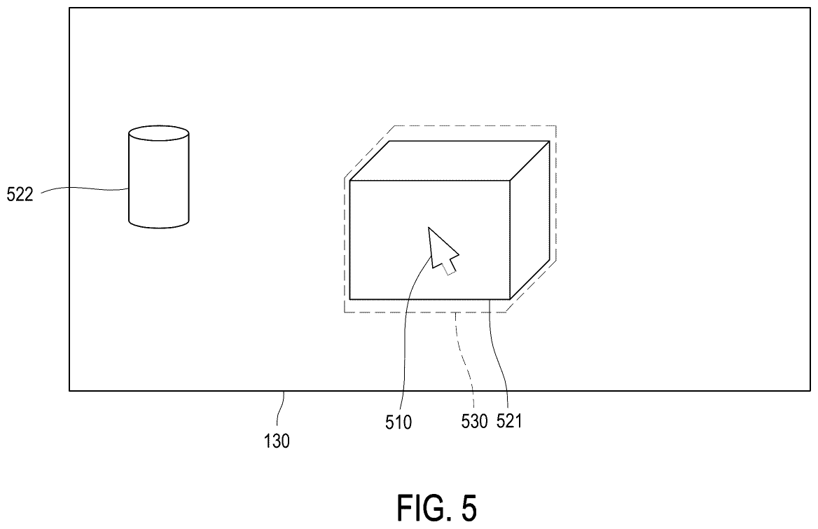

FIG. 5 is a schematic diagram of an “attention area” shown according to another embodiment of the invention. Based on the operation of the user on the user interface device 10, the mouse pointer 510 may move to any location of the display panel unit 130. In response to the mouse pointer 510 being located on a certain object displayed on the display panel, the “attention area” may be the entirety of the “object area” corresponding to the object. For example, in the embodiment shown in FIG. 5, the display panel unit 130 may display a plurality of objects, such as an object 521 and an object 522. As an example of an operating situation, it is assumed that the user moves the mouse pointer 510 to the object 521. Based on the location of the mouse pointer 510, the calculation unit 110 may define the entirety of an object area 530 corresponding to the object 521 as the attention area corresponding to the mouse pointer 510, and other display areas as non-attention areas.

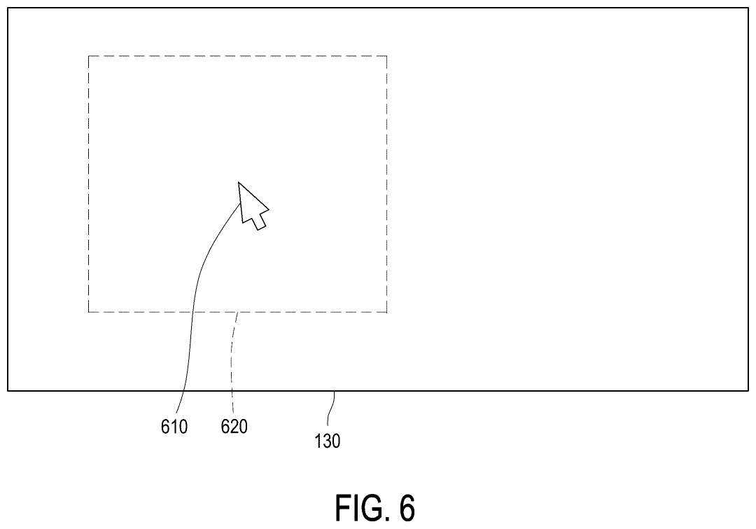

FIG. 6 is a schematic diagram of an “attention area” shown according to another embodiment of the invention. Based on the operation of the user on the user interface device 10, a mouse pointer 610 may move to any location of the display panel unit 130. In response to the location of the mouse pointer 610 on the display panel unit 130, the calculation unit 110 may define an “attention area” 620 including the mouse pointer 610. The geometry of the attention area 620 may be determined according to actual design and/or operating conditions. The shape or the range area of the attention area 620 corresponding to the location of the mouse pointer 610 may both be adjusted via the user control interface. For example, based on the location of the mouse pointer 610, the attention area 620 may be a circle, an ellipse, a rectangle, etc., and the respective corresponding diameters, lengths, and widths, etc. thereof. In addition, the calculation unit 110 may define the attention area 620 shown in FIG. 6, and other display areas are non-attention areas.

Please refer to FIG. 1 and FIG. 2. The local dimming driving unit 140 is coupled to the calculation unit 110. Based on the control of the calculation unit 110, the local dimming driving unit 140 may drive the backlight unit 150 to provide backlight to the display panel unit 130. In step S240, based on information provided by the calculation unit 110, the local dimming driving unit 140 may enable a local dimming function for the attention area corresponding to the location of the mouse pointer, and/or disable the local dimming function for a non-attention area outside the attention area. Therefore, the display device 100 may independently enable or disable the local dimming function for different locations in the image data to reduce hardware computing resources.

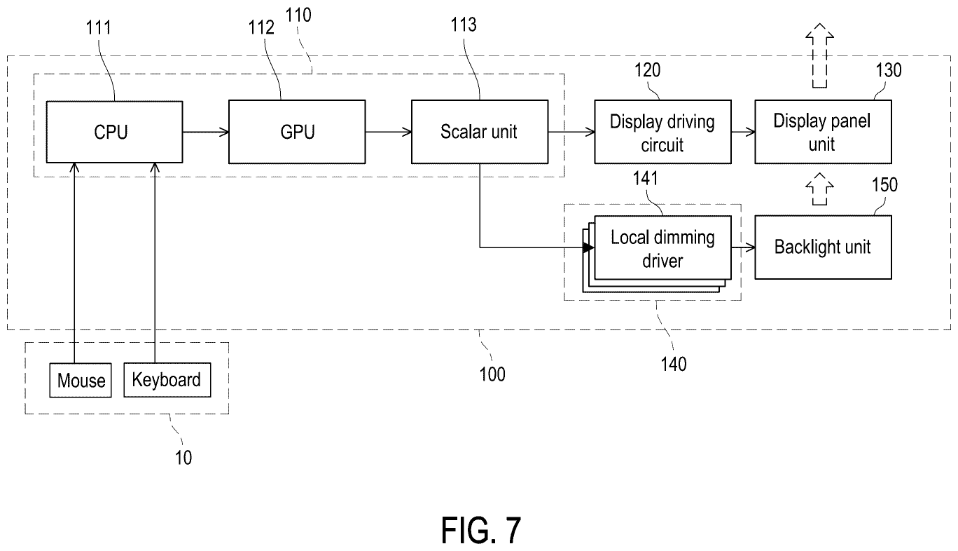

FIG. 7 is a schematic circuit block diagram of the calculation unit 110 and the local dimming driving unit 140 shown according to an embodiment of the invention. In the embodiment shown in FIG. 7, the calculation unit 110 includes a central processing unit (CPU) 111, a graphics processing unit (GPU) 112, and a scalar unit 113, and the local dimming driving unit 140 includes a plurality of local dimming drivers 141. The central processing unit 111 may determine the location of the mouse pointer based on the operation of the user interface device 10. The graphics processing unit 112 is coupled to the central processing unit 111. The scalar unit 113 is coupled to the GPU 112.

Based on the actual design, in some embodiments, the CPU 111 may define the attention area corresponding to the mouse pointer based on the location of the mouse pointer. Based on the attention area defined by the CPU 111, the GPU 112 controls the local dimming driving unit 140 via the scalar unit 113 to selectively enable the local dimming function for the attention area corresponding to the location of the mouse pointer, or disable the local dimming function for the non-attention area.

Based on actual design, in some other embodiments, the GPU 112 may define the attention area corresponding to the mouse pointer based on the location of the mouse pointer. Based on the attention area defined by the GPU 112, the scalar unit 113 controls the local dimming driving unit 140 to selectively enable the local dimming function for the attention area corresponding to the location of the mouse pointer, or disable the local dimming function for the non-attention area.

The plurality of local dimming drivers 141 are coupled to the calculation unit 110. The calculation unit 110 selects at least one attention local dimming driver corresponding to the attention area or at least one non-attention local dimming driver corresponding to the non-attention area from the local dimming drivers 141. The calculation unit 110 enables the local dimming function of the at least one attention local dimming driver, or the calculation unit 110 disables the local dimming function of the at least one non-attention local dimming driver.

Based on the above, the calculation unit 110 may determine the location of the mouse pointer in the image data based on the operation of the user interface device 10. In a general operating situation, the location of the mouse pointer is the specific area that the user is looking at (the attention area). The calculation unit 110 may define an attention area in the image data based on the location of the mouse pointer in the image data. Using the mouse pointer as a guide, the local dimming driving unit 140 may enable the local dimming function for a specific area, and disable the local dimming function in other areas (non-attention areas) outside the specific area. Therefore, the display device 100 may independently enable or disable the local dimming function for different locations in the image data to reduce hardware computing resources.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A display device, comprising:
a calculation unit generating at least one image data for displaying on at least one display panel, wherein the calculation unit determines a location of a mouse pointer in the at least one image data based on an operation of a user interface device, and the calculation unit defines an attention area corresponding to the mouse pointer based on the location of the mouse pointer; and
a local dimming driving unit coupled to the calculation unit, wherein the local dimming driving unit enables a local dimming function for the attention area corresponding to the location of the mouse pointer, or disables the local dimming function for a non-attention area outside the attention area based on information of the calculation unit.

2. The display device of claim 1, wherein the display device comprises a plurality of display panels, and the attention area is a display area of a display panel in the display panels where the mouse pointer is located.

3. The display device of claim 1, wherein a display panel of the display device displays a plurality of screens, and the attention area is an entirety of a screen in the screens where the mouse pointer is located.

4. The display device of claim 3, wherein each of the screens is an application window.

5. The display device of claim 1, wherein in response to the mouse pointer being located on an object displayed on a display panel of the display device, the attention area is an entirety of an object area corresponding to the object.

6. The display device of claim 1, wherein a range area of the attention area corresponding to the location of the mouse pointer may be adjusted via a user control interface.

7. The display device of claim 1, wherein the calculation unit comprises:
a central processing unit determining the location of the mouse pointer based on the operation of the user interface device, and defining the attention area corresponding to the mouse pointer based on the location of the mouse pointer; and
a graphics processing unit coupled to the central processing unit, wherein the graphics processing unit controls the local dimming driving unit via a scalar unit based on the attention area defined by the central processing unit to selectively enable the local dimming function for the attention area corresponding to the location of the mouse pointer, or disable the local dimming function for the non-attention area.

8. The display device of claim 1, wherein the calculation unit comprises:
a central processing unit determining the location of the mouse pointer based on the operation of the user interface device;
a graphics processing unit coupled to the central processing unit, wherein the graphics processing unit defines the attention area corresponding to the mouse pointer based on the location of the mouse pointer; and
a scalar unit coupled to the graphics processing unit, wherein the scalar unit controls the local dimming driving unit based on the attention area defined by the graphics processing unit to selectively enable the local dimming function for the attention area corresponding to the location of the mouse pointer, or disable the local dimming function for the non-attention area.

9. The display device of claim 1, wherein the local dimming driving unit comprises:
a plurality of local dimming drivers coupled to the calculation unit, wherein the calculation unit selects at least one attention local dimming driver corresponding to the attention area or at least one non-attention local dimming driver corresponding to the non-attention area from the local dimming drivers, and the calculation unit enables the local dimming function of the at least one attention local dimming driver, or the calculation unit disables the local dimming function of the at least one non-attention local dimming driver.

10. An operation method of a display device, comprising:
generating at least one image data for displaying on at least one display panel via a calculation unit of the display device;
determining a location of a mouse pointer in the at least one image data based on an operation of a user interface device via the calculation unit;
defining an attention area corresponding to the mouse pointer based on the location of the mouse pointer via the calculation unit; and
enabling a local dimming function for the attention area corresponding to the location of the mouse pointer, or disabling the local dimming function for a non-attention area outside the attention area based on information of the calculation unit via a local dimming driving unit of the display device.

11. The operation method of claim 10, wherein the display device comprises a plurality of display panels, and the attention area is a display area of a display panel in the display panels where the mouse pointer is located.

12. The operation method of claim 10, wherein a display panel of the display device displays a plurality of screens, and the attention area is an entirety of a screen in the screens where the mouse pointer is located.

13. The operation method of claim 12, wherein each of the screens is an application window.

14. The operation method of claim 10, wherein in response to the mouse pointer being located on an object displayed on a display panel of the display device, the attention area is an entirety of an object area corresponding to the object.

15. The operation method of claim 10, further comprising:
adjusting a range area of the attention area corresponding to the location of the mouse pointer via a user control interface.

16. The operation method of claim 10, further comprising:
determining the location of the mouse pointer based on the operation of the user interface device via a central processing unit of the calculation unit;
defining the attention area corresponding to the mouse pointer based on the location of the mouse pointer via the central processing unit; and
controlling the local dimming driving unit via a scalar unit based on the attention area defined by the central processing unit via a graphics processing unit of the calculation unit to selectively enable the local dimming function for the attention area corresponding to the location of the mouse pointer, or disable the local dimming function for the non-attention area.

17. The operation method of claim 10, further comprising:
determining the location of the mouse pointer based on the operation of the user interface device via a central processing unit of the calculation unit;
defining the attention area corresponding to the mouse pointer based on the location of the mouse pointer via a graphics processing unit of the calculation unit; and
controlling the local dimming driving unit based on the attention area defined by the graphics processing unit via a scalar unit of the calculation unit to selectively enable the local dimming function for the attention area corresponding to the location of the mouse pointer, or disable the local dimming function for the non-attention area.

18. The operation method of claim 10, further comprising:
selecting at least one attention local dimming driver corresponding to the attention area or at least one non-attention local dimming driver corresponding to the non-attention area from a plurality of local dimming drivers of the local dimming driving unit via the calculation unit; and
enabling the local dimming function of the at least one attention local dimming driver or disabling the local dimming function of the at least one non-attention local dimming driver via the calculation unit.
